(19) United States
(12) Patent Application Publication
(10) Pub. No.: US 2020/0094333 A1
(43) Pub. Date: Mar. 26, 2020

(54) SEPARATING DEVICE AND MACHINING DEVICE WITH SEPARATING DEVICE

(71) Applicant: HOMAG GmbH, Schopfloch (DE)

(72) Inventors: Martin CALMBACH, Horb-Diessen (DE); Martin GRINGEL, Strassberg (DE)

(21) Appl. No.: 16/612,345

(22) PCT Filed: May 17, 2018
(86) PCT No.: PCT/EP2018/062893

§ 371 Date: Nov. 8, 2019

(30) Foreign Application Priority Data
May 19, 2017 (DE) 10 2017 208 536.3

(51) Int. Cl. B23D 47/12; B23Q 5/04

(52) U.S. Cl. CPC B23D 47/123; B23Q 5/045

(57) ABSTRACT

The invention relates to a separating device which is used for machining of workpieces, preferably workpieces made from wood, wood materials, insulating materials or composite materials.

The present invention relates to a separating device which is used for machining of workpieces, preferably workpieces made of wood, wood materials, plastics, insulating materials or composite materials. Such workpieces are preferably plate-shaped workpieces, as used in the furniture or components industry.

### PRIOR ART

In the prior art, machining devices are known which are equipped with a separating device for separating plate-shaped workpieces. For example, a sawing unit is stored in a tool changer, which is inserted into a spindle unit of a machining device if required. The circular sawing unit is subsequently operated with the machining spindle in order to carry out a cutting operation on a workpiece.

However, conventional sawing units have the disadvantage of taking up a relatively large space while cutting depths are relatively limited.

### SUBJECT MATTER OF THE INVENTION

One aim of the present invention is to provide a separating device which can also be used to cover a wider range of machining operations.

The subject matter of claim 1 provides such a separating device. Further preferred embodiments are specified in the dependent claims and are explained in the following description. Furthermore, the present invention provides a machining device with such a separating device, as well as a use of the separating device.

The separating device according to the invention comprises a transmission element provided for eccentrically driving a rotatable separating element, in particular a saw blade, and a rotating shaft configured to receive a rotating movement for driving the transmission element. In this regard, it is provided that a portion of the rotating shaft can be inserted into a spindle unit of a machining device. The rotating shaft is thus configured in such a way that it can be inserted into a spindle unit of a machining device.

Such a separating device enables a greater cutting depth while at the same time reducing the interference contour. In this way, the range of machining operations can be further increased compared to conventional separating devices. Furthermore, it is preferred that the separating device is a ring saw.

In accordance with a preferred embodiment, it is provided that the rotating shaft can be inserted into a hollow shank taper (Hohlschaftkegel—HSK) of a spindle unit. The hollow shank taper can preferably be a HSK F63 spindle or alternatively an E63 spindle, preferably according to DIN69893. It is therefore possible to use the separating device with a spindle unit, which can also receive other tools, e.g. a milling and/or drilling tool.

According to a further embodiment, it is provided that the transmission element is connected to the rotating shaft via a gear, in particular a toothed gear.

In addition to the receiving device for receiving a rotatable element, it is provided, in accordance with a preferred embodiment, that the separating device comprises a saw blade as separating element, the separating element being provided for woodworking.

In accordance with a preferred embodiment, the separating device is also equipped with a suction device in order to be able to suck off machining residues, in particular wood chips. This makes it easier to clean the separating device and preferably also a machining device with which the separating device is used.

As a further embodiment, the separating device can be equipped with a chip guide plate in order to deflect machining residues, in particular wood chips. This avoids large-area contamination of the surroundings of the separating device.

In an embodiment of the present invention, it is provided that the separating device has a multipart housing, the housing part which receives the receiving device being pivotable relative to the further housing part. A multipart housing makes the replacement of possible defective elements easier. If two housing parts can be swiveled relative to each other, further machining options can be implemented. For example, oblique cuts can be carried out (swiveling about the B axis).

It may also be provided that the separating device has an electronic interface for being able to receive energy and/or data from the spindle unit. In this way, the flexibility of the separating device is further increased.

For example, the separating device can be equipped with sensors that record information directly in the machining area, e.g. the actual speed of the saw blade, ambient temperature, position sensor.

Alternatively or additionally, a pneumatic interface can be provided to create a fluid connection.

According to one embodiment, it is provided that the separating element can be received at the separating device in such a way that an axis of rotation of the separating element extends in perpendicular to the axis of rotation of the rotating shaft or in parallel to the axis of rotation of the rotating shaft. Thus, cuts can be made in vertical or horizontal directions.

Furthermore, the present invention relates to a machining device for machining of workpieces made of wood, wood materials, plastics or composite materials, said machining device relating to a spindle unit and a separating device according to one of the variants described above. The spindle unit can drive the rotating shaft of the separating device.

By using such a separating device in combination with a machining device equipped with a spindle unit, the already mentioned advantages, in particular the increased cutting depth, can be exploited for industrial applications. The user thus has completely new machining possibilities, which increases the application possibilities of the machining device.

It is preferred that the machining device comprises a tool magazine, the separating device being insertable into the tool magazine of the machining device. Furthermore, the separating device can be removed from the tool magazine again. The separating device is thus integrated into the machining device.

According to a further embodiment, it is provided that the spindle unit can be moved in several translational and at least one rotational axis, preferably with at least two rotational axes. In this way, in combination with the separating device, an increased range of machining operations is provided.

In a further embodiment, it is provided that the machining device has a support element, in particular a portal, a jib and a robot arm. A workpiece receptacle is also provided, in particular a workpiece table or one or more consoles.

The present invention further relates to the use of a separating device in a machining device for machining of wood, wood material, plastic, foam material, an insulating mat, a composite material, or a combination thereof, wherein the separating device comprises a transmission element for eccentrically driving the separating element, in particular a saw blade, and a rotating shaft which is configured to receive a rotating movement for driving the transmission element, it being preferred that the rotating shaft can be inserted at least partially into a spindle unit of a machining device.

When using such a separating device with a machining device, it is possible to increase the range of machining operations for cutting operations. In particular, a higher cutting depth can be achieved with a relatively small interference contour.

The advantages of the separating device are particularly evident when cutting comparatively soft or flexible materials such as foam material, an insulating mat (at least partially made of wood fibers, for example), an insulating board (at least partially made of polystyrene, for example) or the like.

The above-mentioned variants of the separating device can be utilized when using the separating device. Furthermore, it is preferred that the separating device is used in combination with an embodiment of the aforementioned machining device.

### BRIEF DESCRIPTION OF THE DRAWINGS

FIG. 1 is a schematic plan view of a machining device with a spindle unit.

FIG. 2 shows a first embodiment of a separating device according to the invention with the spindle unit.

FIG. 3 shows a second embodiment of a separating device according to the invention with the spindle unit.

FIG. 4 shows a third embodiment of a separating device according to the invention with the spindle unit.

### DETAILED DESCRIPTION OF THE PREFERRED EMBODIMENTS

Below, the preferred embodiments of the present invention are explained in detail by means of the enclosed figures. Further modifications of certain individual features mentioned in this context can be combined with each other to form further embodiments.

The embodiments described below are intended to illustrate the present invention using several examples. The described embodiments are therefore not to be regarded as restrictive but serve the better understanding of the present invention.

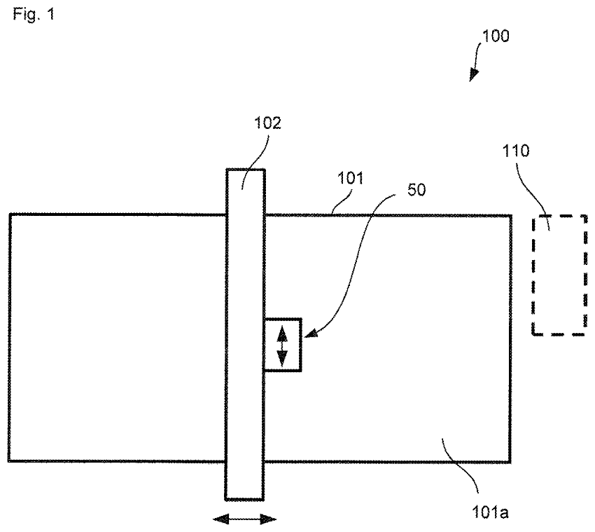

In the schematic plan view of FIG. 1, a machining device 100 is schematically shown, which in the present embodiment example is equipped with a portal 102 as an example of a support element. Further embodiments relate to machining devices, which are equipped with a jib, a robot arm or the like.

The machining device 100 described within the scope of the present embodiment is provided for machining of workpieces made of wood, wood materials, plastic, foam material, fiber material or a composite material so that the machining device 100 is used in the furniture and components industry.

At the portal 102 of the machining device 100, a spindle unit 50 is attached which can be moved along the portal 102. A double arrow (on the spindle unit 50) in FIG. 1 indicates the movement of the spindle unit 50 in relation to the portal 102.

The portal 102 extends over a machine bed 101 and can be moved along this (indicated by a double arrow below the representation of the portal), wherein in the present embodiment example the machine bed 101 is provided with a support table 101a.

Adjacent to the machine bed 101, a tool magazine 110 is provided in which various machining tools can be accommodated. In the present embodiment example, the position of the tool magazine 110 is only schematically indicated and can be varied as needed depending on the specific type of application.

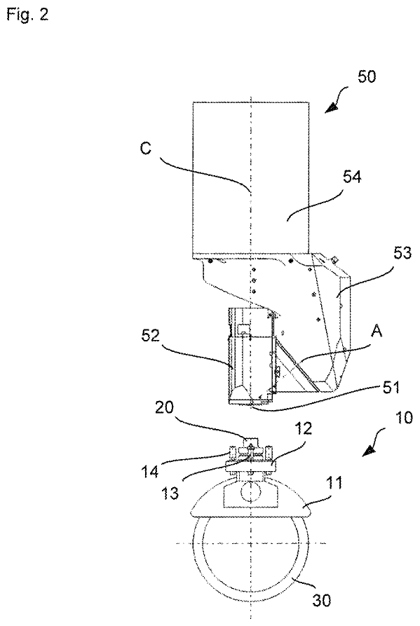

FIG. 2 shows a first embodiment of a separating device 10 according to the invention, which can be inserted into an interface 51 of the spindle unit 50. The spindle unit 50 in FIG. 2 is configured as a so-called 5-axis spindle unit.

The interface 51 of the spindle unit 50 is provided in a receptacle 52 of the spindle unit 50. The receptacle 52 is pivotable relative to a base portion 53 of the spindle unit 50 about an axis A, and the base portion 53 is pivotable about an axis C to the mounting portion 54 of the spindle unit 50. The mounting portion 54 of the spindle unit 50 is attached to the portal 102 or a carriage movable along the portal.

The separating device 10 comprises a receiving device 11, in which a saw blade 30 is partially received. In the present embodiment example, the saw blade 30 is particularly suitable for machining of insulating material or wood.

The saw blade 30 is supported eccentrically in the receiving device 11. Thus, a transmission element (not shown), which is received in the receiving device 11, can engage the saw blade 30 and drive it rotationally.

The receiving device 11 is connected to a housing 12, through which a rotating shaft 20 extends and is supported in the housing 12. The rotating shaft 20 can be rotated relative to the housing 12. An end portion of the rotating shaft 20 protruding from the housing 12 is formed so as to be insertable into an HSK receptacle of the interface 51 of the spindle unit 50.

The upper section of housing 12 is provided with a driving pin 13 as well as receiving pins 14. The pins 13, 14 extend in parallel to the rotating shaft 20. The pins 13, 14 can be inserted into corresponding receptacles of the spindle unit 50 so that the separating device 10 can be swiveled about an axis corresponding to the rotating axis of the rotating shaft 20.

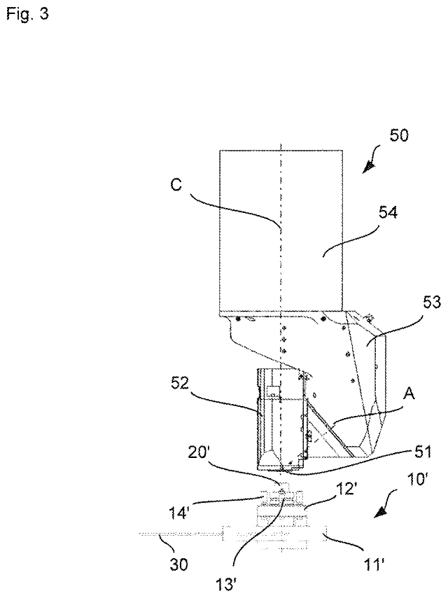

If the separating device 10 is supported by a 5-axis head, as shown in FIGS. 2 and 3, the separating device 10 itself is usually not rotated relative to the spindle unit 50. However, by means of the receiving pins 14, the separating device 10 is fixed precisely in position at the spindle unit 50 and can be rotated about the C axis with the spindle unit 50.

In the case of a 4-axis head (not shown in the drawings), for example, the support is directly in the C-axis. There, the separating device 10 can be rotated relative to the spindle unit 50.

The rotating shaft 20 is configured in such a way that it can be inserted into a hollow shank taper (HSK F63 or E63). The hollow shank taper is preferably configured according to DIN 69893. A rotating movement is transmitted to the rotating shaft 20 via the hollow shank taper, the rotating shaft 20, as already explained, engaging with a saw blade via the transmission element.

FIG. 3 shows a further embodiment of the present invention. The separating device is configured in such a way that it can receive a saw blade 30 in a horizontal orientation. The saw blade 30 extends in a plane perpendicular to the axis of rotation of the rotating shaft 20′ of the separating device 10′. Correspondingly, the receiving device 11′ of the separating device 10′ according to the second embodiment, in comparison with the first embodiment, is configured for horizontal reception of the saw blade 30.

Further elements of the separating device 10′ are configured to be identical or similar to those of the separating device 10. In particular, the separating device 10′ has a housing 12′ from which a driving pin 13′ and receiving pins 14′ extend adjacent to the rotating shaft 20′.

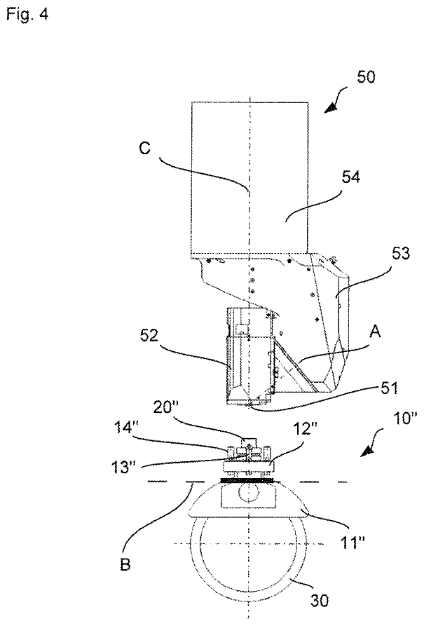

In addition to the embodiments shown in FIGS. 2 to 3, in which the saw blade 30 is received in the respective separating device in a horizontal or vertical orientation, a further embodiment is also conceivable in which the separating device can be swiveled about an axis of its own in order to vary the orientation of the saw blade depending on the type of application. FIG. 4 shows an example of such a separating device 10″.

FIG. 4 shows a third embodiment which essentially differs from the embodiment shown in FIG. 2 in that the separating device 10″ has a multipart housing, a receiving device 11″ being pivotable relative to the further housing part 12″. The pivotability is illustrated in FIG. 4 by the additionally provided B-axis.

Further elements of the separating device 10″ are identical or similar to those of the separating device 10 or 10″. In particular, the separating device 10″ has a housing 12″, from which a driving pin 13″ and receiving pins 14″ extend adjacent to the rotating shaft 20″.

With the separating devices 10, 10′, 10″ described above, thicker workpieces can also be machined without having to insert a separating device with a larger-diameter saw blade into the interface 51 of the spindle unit 50. During machining, the saw blade 30 can be inserted so deeply into a workpiece until the workpiece abuts the receiving device 11, 11′, 11″. Thus, in addition to the radius of the saw blade 30, an increased cutting depth is available where the distance to the receiving device 11, 11′, 11″ is added to the diameter of the saw blade 30. In this way, the range of machining operations for a separating device can be further increased without having to use a separating device with a larger saw blade.

Moreover, modifications of the described embodiments are conceivable in which the separating device has a suction device in order to suck off machining residues, in particular wood chips, and/or a chip guide plate is provided on the separating device, in particular on the housing 12, 12′, 12″ of the separating device 10, 10′, 10″, in order to deflect machining residues, in particular wood chips.

In addition to the embodiments of a spindle unit shown in the figures, other spindle units can also be provided to receive the separating device. In particular, a 3-axis, 4-axis, 5-axis or 6-axis spindle unit can be configured accordingly. A machining device can also have several of these spindle units, the separating device being insertable into one or more of these spindle units.

1. A separating device comprising:
a transmission element provided for eccentrically driving a rotatable separating element, and
a rotating shaft configured to receive a rotating movement for driving the transmission element,
wherein a portion of the rotating shaft can be inserted into an interface of a spindle unit of a machining device.

2. A separating device according to claim 1, characterized in that the rotating shaft can be inserted into a hollow shank taper of a spindle unit.

3. A separating device according to claim 2, characterized in that the hollow shank taper is an HSK F63 spindle.

4. A separating device according to claim 1, characterized in that the transmission element is connected to the rotating shaft via a toothed gear.

5. A separating device according to claim 1, characterized in that the separating device is a ring saw.

6. A separating device according to claim 1, characterized in that the separating element is a saw blade or a saw ring for woodworking.

7. A separating device according to claim 1, characterized in that the separating device comprises a suction device in order to suck off machining residues.

8. A separating device according to claim 1, characterized in that the separating device has a chip guide plate in order to deflect machining residues.

9. A separating device according to claim 1, characterized in that the separating device has a multipart housing, the housing part which receives a receiving device for the separating element being pivotable relative to a further housing part.

10. A separating device according to claim 1, characterized in that the separating device has an electronic interface for being able to receive energy and/or data from the spindle unit.

11. A separating device according to one claim 1, characterized in that the separating element can be received at the separating device in such a way that an axis of rotation of the separating element extends in perpendicular to the axis of rotation of the rotating shaft or in parallel to the axis of rotation of the rotating shaft.

12. A machining device for machining of workpieces made of wood or wood materials, comprising a spindle unit and a separating device according to claim 1, the separating device being drivable via the spindle unit.

13. A machining device according to claim 12, characterized in that the machining device comprises a tool magazine, wherein the separating device can be inserted into the tool magazine of the machining device.

14. A machining device according to claim 12, characterized in that the spindle unit is movable in a plurality of translational and at least one rotational axes.

15. A machining device according to claim 12, characterized in that the machining device comprises a support element, wherein the support element is a portal, a jib or a robot arm, and a workpiece receptacle, wherein the workpiece receptacle is a workpiece table or one or more consoles.

16. Use of a separating device in a machining device for machining of wood, wood material, plastic, foam material, an insulating mat, insulating board, a composite material, or a combination thereof, wherein the separating device has a transmission element for eccentrically driving a rotatable separating element, and a rotating shaft configured to receive a rotating movement for driving the transmission element, wherein the rotating shaft can be inserted at least partially into an interface of the spindle unit of a machining device.

17. A separating device according to claim 1, wherein the separating device has a pneumatic interface.

18. A machining device according to claim 12, wherein the spindle unit is moveable in at least two rotational axes.
